(19) United States
(12) Patent Application Publication
(10) Pub. No.: US 2003/0081593 A1
(43) Pub. Date: May 1, 2003

(54) Method for charging internet phone network

(75) Inventor: Jin Yoel Yoo, Goonpo-si (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/277,975

(22) Filed: Oct. 23, 2002

(30) Foreign Application Priority Data
Oct. 30, 2001 (KR) 67214/2001

(51) Int. Cl. H04L 12/66

(52) U.S. Cl. 370/352; 379/114.01

(57) ABSTRACT

Disclosed is a method for charging Internet phone network usage which can impose charges by transmitting charge information obtained by a gateway to a gatekeeper by using a DRQ message. The gateway calculates a call time by using a call connect time and a call release complete time, and transmits charge information including the call time to the gatekeeper by using the DRQ message. The gatekeeper extracts the charge information from the DRQ message, and imposes charges. As a result, when the gateway or gatekeeper itself obtains the charge information and imposes charges, load is not concentrated and a special protocol is not necessary.

### BACKGROUND OF THE INVENTION

1. Field of the Invention

The present invention relates to an Internet phone network, and more particularly to a method for charging for use of an Internet phone network that can impose charges according to charge information from a gateway in a gatekeeper direct mode of the Internet phone network.

2. Background of the Related Art

The Internet has reformed how data communication is performed, and has also expanded its use into voice communication due to the development of Internet phones. After the computer and telecommunication integration (CTI) disclosed voice over Internet protocol (VoIP) solutions that can transmit/receive Internet protocol (IP) with a voice signal, the use of Internet phone technology has rapidly spread.

VoIP not only connects city or country communication networks in a real time, but can also reduce large communication expenses. VoIP is a communication technology that allows subscribers to perform voice communication using the Internet, as opposed to using a general telephony network. Accordingly, subscribers can carry out what would have been a high-priced telephone service, such as an international call or a long distance call, with only a local call fee.

As a result, the Internet, which is a worldwide common communication network, leads to VoIP communication.

Recently, a gateway using the VoIP technology has been used commercially. Therefore, subscribers can easily use an Internet phone through the connection procedure of telephone-gateway-Internet-gateway-telephone.

FIG. 1 illustrates a general Internet phone network using the H.323 protocol. Referring to FIG. 1, the Internet phone network includes at least one gateway 11 and 12 using the VoIP for matching an IP-based voice service between each PSTN 5 and 15 and the Internet 7. It further includes a gatekeeper 13 for providing Internet phone service to the gateways 11 and 12, and for managing IP addresses, phone numbers, and call setups of each terminal 3 and 17. Here, the gatekeeper 13 performs an address variation function for varying an Alias address and a transport address, a call control signaling function for connecting call signaling channels of each terminal, and a call admission function for admitting a call request by using a H.225 registration admission status (RAS) message. The RAS message includes low messages such as ARQ, ACF, DRQ, DCF, RRQ, and RCF.

A call routing method for a Internet phone network is divided into two modes. The first is a gatekeeper routed mode, wherein the gatekeeper receives the RAS message and call setup message from the gateway and processes the received messages. The second mode is a gatekeeper direct mode, where the gatekeeper receives only the RAS message from the gateway and processes the received message, and the call setup message is processed between the gateways.

FIG. 2 illustrates the processing of the RAS message and the call setup message in the gatekeeper routed mode of FIG. 1. As shown in FIG. 2, when the originating side terminal 3 intends to perform a call with the terminating side terminal 17, the originating side gateway 11 transmits a message (ARQ) to the gatekeeper 13 (S21) to request information about the terminating side gateway 12 where the terminating side terminal 17 is positioned.

The gatekeeper provides a response message (ACF) to the originating side gateway 11 (S23), including the terminating side gateway information and the call routing mode information. The call routing mode information is one of the gatekeeper routed mode and the gatekeeper direct mode. Since FIG. 2 shows the gatekeeper routed mode, the call routing mode information is the gatekeeper routed mode for this example.

The originating side gateway 11 next transmits a call attempt request to the gatekeeper 13, which is a call setup message based on the terminating side gateway information (S25). The gatekeeper 13 transmits the call attempt request to the terminating side gateway 12 by using the setup message (S27).

The terminating side gateway 12 transmits a message (ARQ) to the gatekeeper 13 (S29) to request admission of the currently-attempted call. A response message (ACF), including the call admission result, is the sent from the gatekeeper 13 to the terminating side gateway 12 (S31). The terminating side gateway 12 thus transmits a ringing tone to the terminating side terminal 17, and simultaneously provides an alerting message to the originating side gateway 11 via the gatekeeper 13 (S33 and S35).

When the terminating side terminal 17 responds to the terminating side gateway 12 by going to an off-hook state, the terminating side gateway 12 transmits a connect message to the originating side gateway 11 through the gatekeeper 13. The originating side terminal 3 can then perform the call with the terminating side terminal 17 (S37 and S39).

When the originating side terminal 3 and the terminating side terminal 17 are disconnected, for example due to an on-hook state of the terminating side terminal 17 or a line failure, the terminating side gateway 12 provides a release complete message to the originating side gateway 11 through the gatekeeper 13, thereby finishing the call (S41 and S43).

The originating and terminating side gateways 11 and 12 thereafter transmit a DRQ message, including call disengage and disengage reasons, to the gatekeeper 13. The originating and terminating side gateways 11, 12 then receive a response message (DCF) from the gatekeeper 13 (S45 to S51).

FIG. 3 illustrates the processing of the RAS message and the call setup message in the gatekeeper direct mode of FIG. 1. Same step numbers are provided to same steps as FIG. 2.

As illustrated in FIG. 3, when the originating side terminal 3 intends to perform a call with the terminating side terminal 17, the originating side gateway 11 transmits a message (ARQ) to the gatekeeper 13 (S21) to request information on the terminating side gateway 12 where the terminating side terminal 17.

The gatekeeper provides a response message (ACF) to the originating side gateway 11 (S23), including the terminating side gateway information and the call routing mode information. The call routing mode information is one of the gatekeeper routed mode and the gatekeeper direct mode. Since FIG. 3 shows the gatekeeper direct mode, the call routing mode information is the gatekeeper direct mode in this example.

The originating side gateway 11 next transmits a call attempt request directly to the terminating side gateway 12 by using the setup message, which is the call setup message, based on the terminating side gateway information (S53). That is, while the setup message is transmitted to the terminating side gateway 12 through the gatekeeper 13 in the gatekeeper routed mode, the setup message is transmitted directly to the terminating side gateway 12 in the gatekeeper direct mode.

The terminating side gateway 12 transmits a message (ARQ) to the gatekeeper 13 (S29) to request admission of the currently-attempted call. A response message (ACF), including the call admission result (S31) is then transmitted from the gatekeeper 13 to the terminating side gateway 12. The terminating side gateway 12 transmits a ringing tone to the terminating side terminal 17, and simultaneously transmits an alerting message directly to the originating side gateway 11 (S55).

When the terminating side terminal 17 responds to the terminating side gateway 12 by switching to an off-hook state, the terminating side gateway 12 transmits a connect message directly to the originating side gateway 11, so that the originating side terminal 3 can perform the call with the terminating side terminal 17 (S57).

When the originating side terminal 3 and the terminating side terminal 17 are disconnected due to an on-hook state of the terminating side terminal 17 or line failure, the terminating side gateway 12 provides a release complete message directly to the originating side gateway 11, thereby finishing the call (S59).

The originating and terminating side gateways 11 and 12 transmit a DRQ message, including call disengage and disengage reasons, to the gatekeeper 13, and each receives a response message (DCF) from the gatekeeper 13 (S45 to S51).

As shown in FIGS. 2 and 3, the call setup message (for example, setup message, call message, connect message, and release complete message) is transmitted/received between the originating and terminating side gateways 11 and 12, through the gatekeeper 13, in the gatekeeper routed mode (FIG. 2), but transmitted directly to the originating and terminating side gateways 11 and 12 without passing through the gatekeeper 13 in the gatekeeper direct mode.

The related art Internet phone network calculates a call time for charging purposes by checking a time of receipt of the connect message and a time of receipt of the release complete message.

In the gatekeeper routed mode, the gatekeeper can calculate the call time and self-impose charges for the call time, or transmit charge information, including the call time, to a charging server for charging.

On the other hand, in the gatekeeper direct mode, the call setup message, namely the connect message and the release complete message, do not pass through the gatekeeper, and thus the gateway calculates a call time on the basis of the connect message reaching time and the release complete message reaching time, adds the call time to charge information, and transmits the charge information to the charging server for charging.

Thus, the related art Internet phone network has various problems. For example, when it imposes charges in the gatekeeper routed mode, the call setup message should pass through the gatekeeper, which concentrates load on the gatekeeper.

Moreover, when the related art Internet phone network imposes charges in the gatekeeper direct mode, a special protocol for transmitting the charge information to the charging server is required, which consumes gateway resources.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide a method for charging Internet phone network usage which allows a gatekeeper to impose charges according to charge information provided from a gateway by using a DRQ message in a gatekeeper direct mode.

In order to achieve at least the above objects in whole or in parts, there is provided a method for charging Internet phone network, which transmits charge information, including a call time obtained by at least one gateway, to a gatekeeper by using a DRQ message in a gatekeeper direct mode, and imposes charges according to the charge information.

The call time can preferably be calculated by subtracting a call connect time from a call release complete time. The call connect time implies a time when a connect message is received by or transmitted to at least one gateway, and the call release complete time implies a time when a release complete message is received by or transmitted to at least one gateway.

The charge information is preferably applied to a redundant field of the DRQ message, and may further include a charging ID number, a disengage reason, an originating side terminal type, a terminating side terminal type, an originating side gateway IP address, a terminating side gateway IP address, an originating side terminal phone number, a terminating side terminal phone number, a call connect time, and call release complete time.

Additionally, in order to achieve at least the above objects in whole or in parts, there is provided a method for charging Internet phone network, including calculating a call time from a call connect time and a call release complete time by the originating side gateway; transmitting charge information including the call time to the gatekeeper by using a DRQ message by the originating side gateway; and imposing charges according to the charge information by the gatekeeper.

The call connect time implies a time when a connect message is received by the originating side gateway or transmitted to the terminating side gateway. The call release complete time implies a time when a release complete message is received by the originating side gateway or transmitted to the terminating side gateway. The call connect time and the release complete time can preferably be recorded on a recording means.

Additionally, in order to achieve at least the above objects in whole or in parts, there is provided a method for charging Internet phone network, including recording a call connect time detected from a reception of a connect message on a recording means by at least one gateway; recording a call release complete time detected from a reception of a release complete message on the recording means by at least one gateway; calculating a call time by using the call connect time and the call release complete time by at least one gateway; transmitting charge information including the call time to the gatekeeper by using a DRQ message by at least one gateway; and extracting the charge information from the DRQ message and imposing charges according to the charge information by the gatekeeper.

The method for charging Internet phone network may further include recording a call connect time detected from a transmission of a connect message on a recording means by at least one gateway; recording a call release complete time detected from a transmission of a release complete message on the recording means by at least one gateway; calculating a call time by subtracting the call connect time from the call release complete time by at least one gateway; and transmitting charge information including the call time to the gatekeeper by using the DRQ message by at least one gateway.

Additionally, in order to achieve at least the above objects in whole or in parts, there is provided a method for charging Internet phone network, including performing a communication through a call connection using a connect message between the originating side gateway and the terminating side gateway according to call routing information of the gatekeeper; calculating a call time based on a call release complete from a release complete message generated in response to an external event by the originating side gateway; transmitting the charge information including the call time to the gatekeeper by using a DRQ message by the originating side gateway; and imposing charges using the charge information extracted from the DRQ message by the gatekeeper.

Preferably, the call routing information is a gatekeeper direct mode and the external event is an on-hook state of the terminal or line failure.

To further achieve at least the above objects, in whole or in parts, there is provided an improved DRQ message for transmitting information of an end of an Internet phone call from a gateway to a gatekeeper, the information including a call disengage and disengage reasons, the improvement to the DRQ message being the inclusion of charge information in the DRQ message. The charge information is preferably embedded in a redundant field of the DRQ message, and includes a call duration time of the Internet phone call calculated by subtracting a call connect time from a call release complete time.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a drawing illustrating a related art Internet phone network using the H.323 protocol;

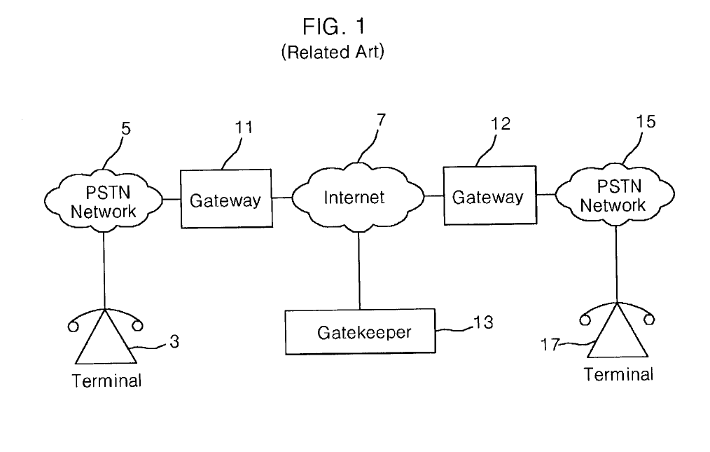

FIG. 2 is a drawing illustrating processing of an RAS message and a call setup message in a gatekeeper routed mode of FIG. 1;

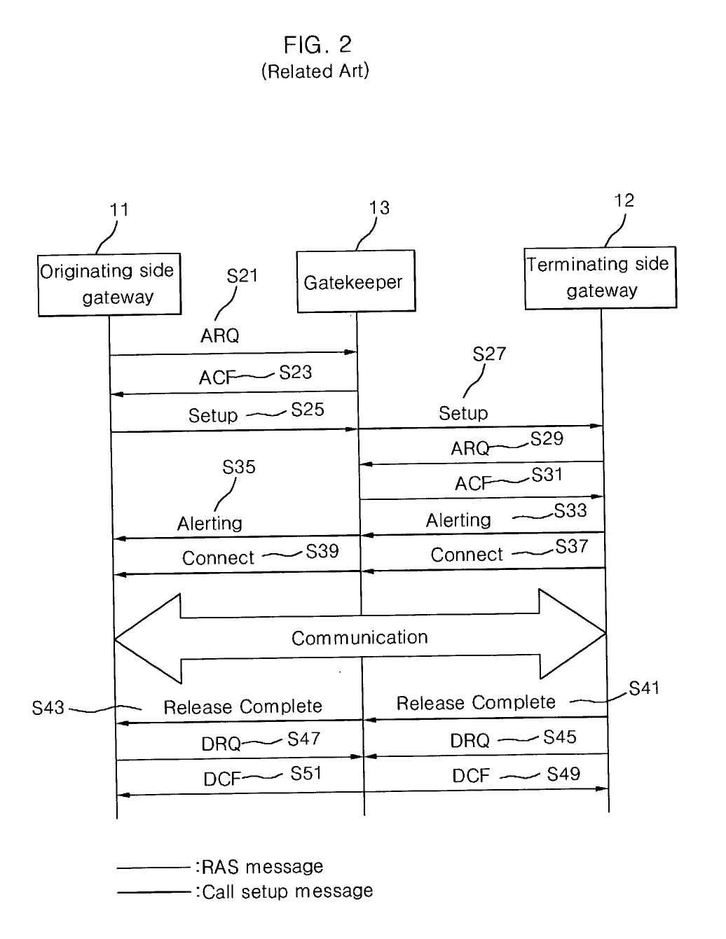

FIG. 3 is a drawing illustrating processing of the RAS message and the call setup message in a gatekeeper direct mode of FIG. 1;

FIG. 4 is a flowchart showing a method for charging Internet phone network in accordance with a preferred embodiment of the present invention; and

FIG. 5 is a drawing illustrating a DRQ message structure for carrying charge information on the Internet phone network in accordance with the preferred embodiment of the present invention.

### DETAILED DESCRIPTION OF PREFERRED EMBODIMENTS

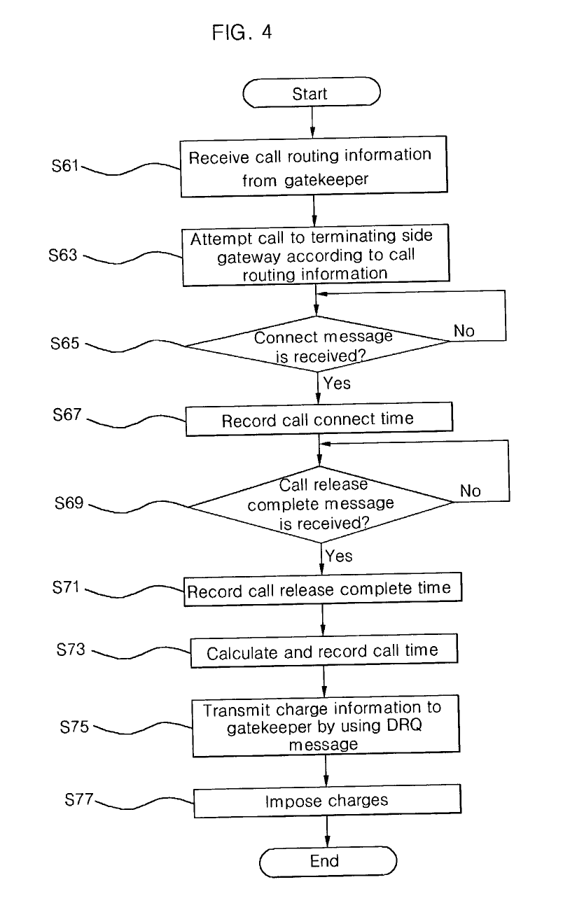

FIG. 4 is a flowchart showing a method for charging Internet phone network usage in accordance with the preferred embodiment of the present invention. Referring to FIG. 4, an originating side gateway requests a call routing method to a gatekeeper, and receives call routing information from the gatekeeper (S61).

As described above, the call routing method for the Internet phone network is divided into a gatekeeper routed mode and a gatekeeper direct mode. The preferred embodiment relates to the charging method in the gatekeeper direct mode. Preferably, the call routing information provided by the gatekeeper is thus the gatekeeper direct mode.

The originating side gateway first attempts a call to a terminating side gateway according to the call routing information, namely the gatekeeper direct mode (S63). The call routing information is the gatekeeper direct mode, and thus the originating side gateway attempts the call directly to the terminating side gateway without passing through the gatekeeper. On the other hand, the originating side gateway confirms reception of a connect message from the terminating side gateway.

As described above, the terminating side gateway requests call attempt admission to the gatekeeper. After receiving the call attempt admission, the terminating side gateway transmits a ringing tone to the terminating side terminal and simultaneously provides an alerting message to the originating side gateway.

When the terminating side terminal responds to the ringing tone in an off-hook state, the terminating side gateway provides the connect message to the originating side gateway. The originating side gateway preferably confirms reception of the connect message (S65).

When the originating side gateway receives the connect message from the terminating side gateway, the originating side gateway preferably records a connection message reception time, which is a call connect time, on a call leg (S67). The call leg is a recording means for recording all information (including charge information) generated on the call between the originating side gateway and the terminating side gateway. It should be understood that any method of logging the call connect time could be used.

Accordingly, the charge information, including an originating side terminal type, terminating side terminal type, originating side gateway IP address, terminating side gateway IP address, originating side terminal phone number, and terminating side terminal phone number which can be previously searched, can be recorded on the call leg before recording the call connect time.

When the originating side gateway receives the connect message, it notifies the originating side terminal and thus the originating side terminal is in an off-hook state, and the originating side terminal and the terminating side terminal can perform the call.

In the case that the call is disconnected due to an on-hook state of any of the terminals or line failure, the call is interrupted between the originating side terminal and the terminating side terminal.

FIG. 4 exemplifies call interruption due to an error of the terminating side, but it should be recognized that an error of the originating side is also included in the technical range of the present invention.

Thus, when the terminating side terminal is in an on-hook state, the terminating side gateway supplies a release complete message to the originating side gateway. Here, the originating side gateway confirms reception of the release complete message (S69).

Upon receiving the release complete message, the originating side gateway preferably records a release complete message reception time, which is a call release complete time, on the call leg (S71).

In addition, the originating side gateway calculates a call time by using the call connect time and the call release complete time recorded on the call leg, and records the resultant value on the call leg (S73).

The call time is preferably calculated by subtracting the call connect time from the call release complete time.

On the other hand, the originating side gateway extracts the charge information, including the call time, from the call leg, and transmits the charge information to the gatekeeper by using the DRQ message (S75).

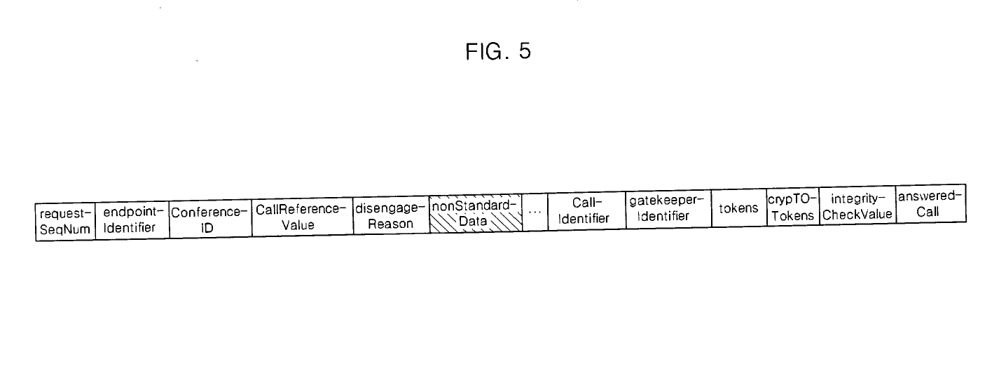

As shown in FIG. 5, the charge information gets loaded in a redundant field. Preferably, it is loaded into the ‘nonStandard-Data’ field. The charge information may include the charging ID number, disengage reason, originating side terminal type, terminating side terminal type, originating side gateway IP address, terminating side gateway IP address, originating side terminal phone number, terminating side terminal phone number, call connect time, and call release complete time in addition to the call time.

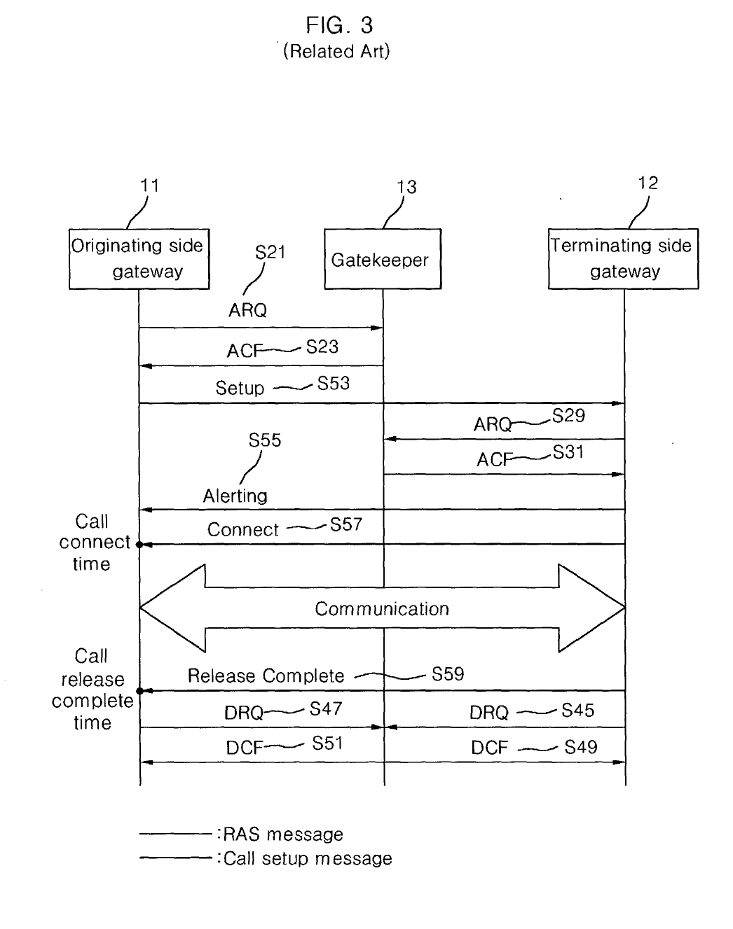

In addition, the DRQ message used to transmit the charge information to the gatekeeper is otherwise identical to the general DRQ message (FIG. 3) used to transmit the call disengage and disengage reasons in the related art. However, it is notable that the charge information gets loaded in the redundant field of the DRQ message in transmission of the call disengage and disengage reasons in the preferred embodiment.

The gatekeeper then extracts the charge information from the DRQ message and self-imposes charges, or transmits the charge information to the charging server for charging (S77).

In this embodiment of the present invention, the originating side gateway obtains the charge information. The terminating side gateway, however, can also obtain the charge information. That is, the terminating side gateway can calculate the call time from the time when the connect message and the release complete message are supplied to the originating side gateway, and transmit it to the gatekeeper with the other information by using the DRQ message for charging.

As discussed above, the preferred embodiment of the present invention has many advantages. For example, the charge information obtained from the gateway is transmitted to the gatekeeper by using the DRQ message, thereby preventing load concentration in the gatekeeper routed mode. Moreover, this method does not require a special protocol for transmitting the charge information to the charging server in the gatekeeper direct mode.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for charging usage time on an Internet phone network system having a gatekeeper and at least one gateway and configured to provide voice communication through the Internet in a gatekeeper direct mode, comprising:
transmitting charge information obtained by the at least one gateway to the gatekeeper as part of a DRQ message, the charge information comprising a call time; and
imposing charges to a user according to the charge information.

2. The method of claim 1, wherein the call time is calculated by subtracting a call connect time from a call release complete time.

3. The method of claim 2, wherein the call connect time is a time when a connect message is received by the at least one gateway.

4. The method of claim 2, wherein the call connect time is a time when a connect message is transmitted to the at least one gateway.

5. The method of claim 2, wherein the call release complete time is a time when a release complete message is received by the at least one gateway.

6. The method of claim 2, wherein the call release complete time is a time when a release complete message is transmitted to the at least one gateway.

7. The method according to claim 1, wherein the charge information is loaded in a redundant field of the DRQ message.

8. The method of claim 1, wherein the charge information further comprises a charging ID number, a disengage reason, an originating side terminal type, a terminating side terminal type, an originating side gateway IP address, a terminating side gateway IP address, an originating side terminal phone number, a terminating side terminal phone number, a call connect time, and a call release complete time.

9. A method for charging usage of an Internet phone network system having an originating side gateway, a terminating side gateway, and a gatekeeper to provide voice communication through the Internet in a gatekeeper direct mode, comprising:
calculating a call time from a call connect time and a call release complete time by the originating side gateway;
transmitting charge information to the gatekeeper as part of a DRQ message by the originating side gateway, the charge information including the call time; and
imposing charges according to the charge information by the gatekeeper.

10. The method of claim 9, wherein the call time is calculated by subtracting the call connect time from the call release complete time.

11. The method of claim 9, wherein the call connect time is a time when a connect message is received by the originating side gateway.

12. The method of claim 9, wherein the call connect time is a time when a connect message is transmitted to the terminating side gateway.

13. The method of claim 9, wherein the call release complete time is a time when a release complete message is received by the originating side gateway.

14. The method of claim 9, wherein the call release complete time is a time when a release complete message is transmitted to the terminating side gateway.

15. The method of claim 9, wherein the charge information is loaded in a redundant field of the DRQ message.

16. The method of claim 9, wherein the charge information is non-standard data of the DRQ message.

17. The method of claim 9, wherein the call connect time and the call release complete time are recorded on a recording means.

18. The method of claim 9, wherein the charge information further comprises a charging ID number, a disengage reason, an originating side terminal type, a terminating side terminal type, an originating side gateway IP address, a terminating side gateway IP address, an originating side terminal phone number, a terminating side terminal phone number, a call connect time, and a call release complete time.

19. A method for charging usage of an Internet phone network system having a gatekeeper and at least one gateway and configured to provide voice communication through the Internet in a gatekeeper direct mode, comprising:
recording a call connect time detected from a reception of a connect message by the at least one gateway;
recording a call release complete time detected from a reception of a release complete message by the at least one gateway;
calculating a call time by the at least one gateway by using the call connect time and the call release complete time;
transmitting charge information from the at least one gateway to the gatekeeper as part of a DRQ message, the charge information including the call time; and
extracting the charge information from the DRQ message by the gatekeeper.

20. The method of claim 19, wherein the call connect time and the call release complete time are recorded on a recording means.

21. The method of claim 20, wherein the recording means is a call leg.

22. The method of claim 19, further comprising imposing charges to a user based on the charge information.

23. The method of claim 19, further comprising:
recording a call connect time detected from a transmission of a connect message on a call leg by the at least one gateway;
recording a call release complete time detected from a transmission of a release complete message on the call leg by the at least one gateway;
calculating a call time by subtracting the call connect time from the call release complete time by the at least one gateway; and
transmitting charge information including the call time from the at least one gateway to the gatekeeper as part of the DRQ message.

24. The method of claim 19, wherein the charge information is loaded onto a redundant field of the DRQ message.

25. The method of claim 19, wherein the charge information further comprises a charging ID number, a disengage reason, an originating side terminal type, a terminating side terminal type, an originating side gateway IP address, a terminating side gateway IP address, an originating side terminal phone number, a terminating side terminal phone number, a call connect time, and a call release complete time.

26. A method for charging use of an Internet phone network system having an originating side gateway, a terminating side gateway, and a gatekeeper and configured to provide voice communication through the Internet, comprising:
performing a communication through a call connection using a connect message between the originating side gateway and the terminating side gateway according to call touting information of the gatekeeper;
calculating a call time based on a call release complete from a release complete message generated in response to an external event by the originating side gateway; and
transmitting the charge information, including the call time, from the originating side gateway to the gatekeeper as part of a DRQ message.

27. The method of claim 26, further comprising imposing charges using the charge information extracted from the DRQ message by the gatekeeper.

28. The method of claim 26, wherein the call routing information is a gatekeeper direct mode.

29. The method of claim 26, wherein the call time is calculated by subtracting a call connect time from a call release complete time.

30. The method of claim 26, wherein the external event is one of an on-hook state of the terminal and a line failure.

31. An internet phone network system, comprising:
an originating side gateway configured to calculate a call time according to a call connect time and a call release complete time;
a terminating side gateway configured to receive a call from the originating side gateway; and
a gatekeeper to provide voice communication between the originating side gateway and the terminating side gateway through the internet in a gatekeeper direct mode, wherein the originating side gateway is further configured to transmit charge information comprising the call time to the gatekeeper as part of a DRQ message.

32. The system of claim 31, wherein the originating side gateway calculates the call time by subtracting the call connect time from the call release complete time.

33. The system of claim 31, further comprising a recording means to record the call connect time and a call release complete time.
